(19) United States
(12) Patent Application Publication
(10) Pub. No.: US 2013/0218708 A1
(43) Pub. Date: Aug. 22, 2013

(54) Timed Online Auction Events

(71) Applicant: NextLot, Inc., (US)

(72) Inventors: Scott Daryl Finkelstein, Raleigh, NC (US); Matthew Brian Henderson, Raleigh, NC (US)

(73) Assignee: NEXTLOT, INC., Raleigh, NC (US)

(21) Appl. No.: 13/771,583

(22) Filed: Feb. 20, 2013

Related U.S. Application Data
(60) Provisional application No. 61/601,877, filed on Feb. 22, 2012.

(51) Int. Cl. G06Q 30/08

(52) U.S. Cl. CPC G06Q 30/08
USPC 705/26.3

(57) ABSTRACT

Techniques for conducting a timed, online auction are described. In an example system, an auction web server sends a current auction price and at least one bid increment to the browser screens of bidder computers. One or more bids are received, wherein each bid is placed according to the then-current bid and the next bid increment. A revision event is triggered by the web site system, whereupon the first bid increment is adjusted, to form a revised bid increment, and the revised bid increment is sent and displayed to bidders. The adjustment of the increment is calculated as a function of the remaining time in the timed auction event, or the ratio of the then-current auction price to a target price for the lot, or both. One or more additional bids are received, wherein the one or more additional bids are based on the revised bid increment.

### RELATED APPLICATIONS

This application claims the benefit of and priority to U.S. Provisional Application Ser. No. 61/601,877, filed 22 Feb. 2012. The entire contents of said U.S. Provisional application are incorporated herein by reference.

### BACKGROUND

The present invention is generally related to online auction systems, and is more particularly related to online auction systems in which bid increments are automatically adjusted to adapt to sale conditions.

Several methods have evolved for conducting a timed auction online, e.g., over the Internet. Like a traditional in-person auction, a timed online auction consists of one or several bidding sessions, each of which takes place over a relatively short period of time. These bidding sessions resemble bidding sessions at an in-person auction sale in several ways. However, the bidding takes place over a computer network rather than in person, and is managed automatically by an auction server, generally without any need for human management of the auction event during the bidding session itself. Further, the bidding for a given lot is generally limited to a fixed time period, and the minimum bid increments are usually predetermined for each lot and remain constant during the bidding for that lot.

U.S. Pat. No. 7,617,145 (hereinafter “the '145 patent”), issued 10 Nov. 2009, describes an online auction system in which bidders place bids on auction lots in an online auction by using one or more predetermined bid increments provided by the system. The system described in the '145 patent provides for adjustment of the predetermined bid increments during the auction of a specific lot, in response to detecting that a pre-determined time has elapsed since a bid was placed. This approach is intended to increase bid activity and optimize the auction result.

One problem with the approach outlined in the '145 patent is that bidders can learn the behavior of the system, and might be encouraged to wait for bid revisions. This can have the effect of reducing excitement and bidding, thus reducing the price ultimately realized by an auction event. Accordingly, improved techniques and systems for conducting timed online auction events are needed.

### SUMMARY

Embodiments of the present invention can be used to simulate, in a timed-online auction environment, an experience similar to that of a live, in-person auction. At a live, English auction, auctioneers accept ascending bids according to a set bid increment. As interest in bidding lessens, the auctioneer will drop the increment to stimulate bidding activity. These drops typically occur a few times during the sale of a lot in order to obtain the highest possible sale price for the item. The skill and experience of the auctioneer have a significant impact on the amount realized by the auction.

Several embodiments of the present invention employ an algorithm, indecipherable to bidders, that automatically changes bid increments in a timed online setting. In several of these embodiments, the algorithm adjusts an increment value due to a combination of two factors: (1) how much time is left in the auction and (2) the ratio of the most recent (i.e., “current”) bid to a target price for the lot. Further, in some embodiments, increments drop at random times so that the bidder is unable to figure out the pattern. For example, when items approach target prices as the auction winds down, increments will drop at certain points to generate more excitement for items to bring higher prices.

In several embodiments of the present invention, a website system conducts an online auction. The current auction price is sent to the browser screens of one or more bidders via the website system. One or more bid increments for selection by the user may be displayed, in some embodiments, including a first predetermined minimum bid increment. The minimum value that the system can accept for the next bid (“minimum next bid value”) may be displayed in the browser as well, or instead of several bid increments. This minimum next bid value is calculated by taking the current bid price and adding to it the first predetermined minimum bid increment selected by the website system. One or more bids are received from the bidders, wherein each bid is placed according to the then-current bid and the next bid increment. A revision event is triggered by the web site system, whereupon the first bid increment is adjusted, to form a revised bid increment, and the revised bid increment is sent and displayed to bidders. One or more additional bids are received, wherein the one or more additional bids are based on the revised bid increment.

In some embodiments, the adjustment of the first bid increment is calculated as a function of the remaining time in a timed auction. In some embodiments, the adjustment of the increment is calculated as a function of the then-current auction price, in some cases as a function of the ratio of the then-current auction price to a target price for the lot. In some embodiments, the adjustment of the increment is calculated as a function of both the remaining time in a timed auction and the ratio of the then-current auction price to a target price for the lot.

In several embodiments, one or more additional revision events are triggered by the auction server system. At each of these additional revision events, the current bid increment is further adjusted, as a function of the time remaining in the auction, the ratio of the then-current auction price to a target price for the lot, or both. In several of these embodiments, the precise time of at least one revision event is randomly selected from a predetermined range of time prior to the end of the timed event.

Embodiments of the invention include methods according to one or more of the above techniques, as implemented by an auction web server comprising a communications interface circuit and at least one processing circuit, in a web server apparatus. Other embodiments include a web server apparatus configured to carry out one or more of these methods, the web server apparatus comprising a processing circuit that, in several embodiments, comprises at least one processor and associated memory, the memory storing executable program instructions for carrying out one or more of the techniques summarized above.

### BRIEF DESCRIPTION OF THE DRAWINGS

FIG. 1 illustrates an example network, comprising an auction web server configured according to the present invention and several network-connected user devices.

FIG. 2 is a process flow diagram illustrating an example method for conducting a timed online auction event.

FIG. 3 is a block diagram illustrating an example web server apparatus.

### DETAILED DESCRIPTION

U.S. Pat. No. 7,617,145, titled “Adaptive Bidding Increments in an Online Auction System” and issued 10 Nov. 2009 (hereinafter referred to as “the '145 patent”), describes systems and methods for conducting an online auction. The entire contents of the '145 patent are incorporated herein by reference for the purpose of providing background and context for the inventive techniques detailed herein.

In the system described by the '145 patent, bid increments at an auction are adjusted in response to a “revision event,” where the revision event is triggered based on the passage of a certain period of time during which there are no bids placed. So, if bidding stalls out at an increment for a certain period of time, the bid increment will adjust. While the present disclosure also describes an adjustable-bid-increment system, the systems contemplated herein use a different approach for determining when revision events occur and/or the extent of the bid increment adjustments. Thus, for example, several embodiments of the present invention adjust bid increments, not based on a period of bidding inactivity, but based on how close a current bid for the item is to the target price for that item, as well as on how much time is left in the auction. Bidders are unaware of both the target price for an item as well as when the revision event is triggered to adjust the bid increment. Because this approach is more dynamic and is more unpredictable than previous approaches, it is more effective in stimulating greater bidding activity at timed, online auctions.

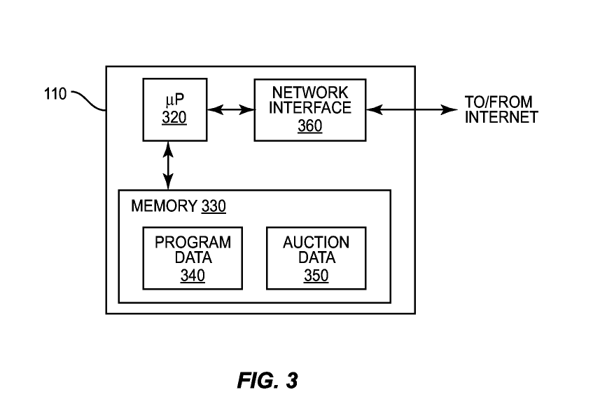

It will be appreciated that the detailed techniques described herein may be used instead of, or in addition to, the techniques described in the '145 patent. Further, it will be appreciated that the detailed techniques described herein may be implemented in or with the systems and apparatus described in the '145 patent. Thus, embodiments of the present invention may be implemented in a system like those illustrated in FIGS. 3 and 4 of the '145 patent, and may include the use of one or more computer programs having a general structure the same as or similar to those described in the '145 patent. However, said systems and computer programs are modified, according to some embodiments of the present invention, to operate according to one or more of the techniques described more fully below.

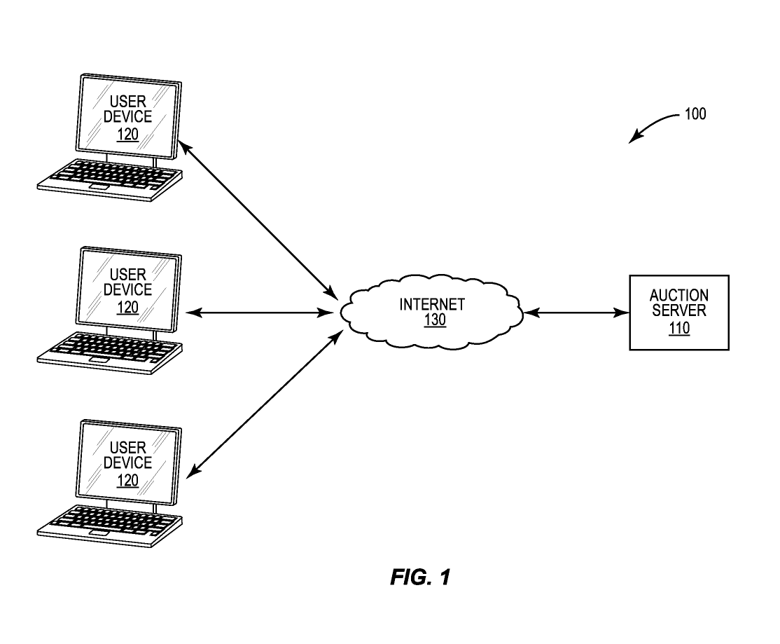

FIG. 1 illustrates an example computer network 100, comprising an auction web server 110 and several user devices (or bidder computers) 120, where the user devices 120 are linked to the auction web server 110 via the Internet 130. While three user devices 120 are illustrated, it will be appreciated that more (or fewer) user devices 120 may be linked to the auction web server 110 at any given time.

Auction web server 110, which may comprise one web server apparatus or several web servers working in tandem, is managed by an auction operator, which arranges the sale of items through an online auction service run over computer network 100 by auction web server 110. Details of the structure and configuration of an example auction web server 110 are provided below.

User devices 120 may be of any type of computing device configured to access servers through the Internet and to facilitate interactive communication with those servers by the device's user. Because of the centralized nature of the auction process, a client-server model of interaction between the user devices 120 and the auction web server 110 is generally used, where the user devices 120 act as the clients. While other approaches are possible, this client-server model of interaction may be most readily implemented through the use of web server functionality on the auction web server 110 and web browser functionality on the user devices 120, where the communications is carried out via standardized protocols such as the Hypertext Transfer Protocol (HTTP). Web browsers may be implemented on a wide variety of user devices; thus, examples of user devices or bidder computers include personal computers, tablet computers, handheld computers including so-called smartphones, and the like. While the discussion that follows may refer to bidder computers or client web browsers, or the like, it should be understood that the techniques described below may be implemented in connection with network-connected user devices more generally.

In several embodiments of the present invention, auction web server 110 is configured, e.g., with appropriate software, firmware, or the like, to communicate with bidder computers 120 via a data network, e.g., over the Internet, and to conduct an online auction in which one or more items, or “lots,” are sold in timed online auction events. It will be appreciated that two or more online auction events may be carried on simultaneously, over the same or overlapping intervals. These simultaneous online auction events may involve the same, different, or overlapping groups of bidder computers 120. Further, it will be appreciated that any given bidder computer's 120 activity and/or communications with the web server 110 may be intermittent, begin sometime after a given auction event has begun, or terminate sometime before the auction event is concluded. The particular techniques described below are designed to encourage participant interest and bidding activity as each auction event draws to a close, thus increasing the price realized by the auction for each item sold.

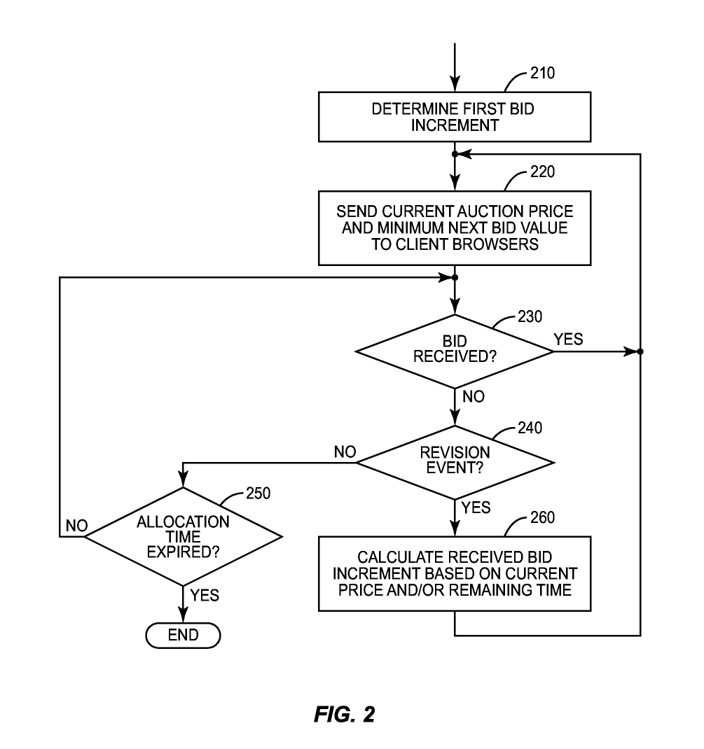

FIG. 2 illustrates a method for conducting an online auction according to some embodiments of the invention. While the process shown in FIG. 2 is associated with a single auction event, i.e., for a single item in an auction (“lot”), several events may take place simultaneously, as noted above, or may be carried out consecutively. It is assumed that lot information for the auction event is available and/or has already been provided to participating users. This may be done, for example, through a web page accessible to users. For instance, the auction web server may provide a main site that includes links to one or more pages for collecting participant information (e.g., identity, communication preferences, mailing address, payment provisions, etc.) and/or links to one or more virtual auction “rooms,” where the page for a given room displays information describing the lot, the time remaining in the auction of that lot (or the start time for the event), the most recent bid price for the item, etc. The details of the overall auction web site presentation and of the general presentation of information for each lot are unnecessary to a full understanding of the present invention, and are thus not elaborated on further herein.

As shown at block 210, a first bid increment for the given timed online auction event is determined. In some embodiments, this first bid increment may be determined as a function of the target price of the auction lot, or a starting auction price, or both. The term “target price” as used herein can refer to any lot-specific, pre-determined price associated with a given lot, such as a reserve price, an expected final price, an endpoint of an expected range of final lot price, or the like. While the target price may be fixed well prior to the beginning of an auction event, in several embodiments of the invention described herein, in other embodiments the target price may be determined up to the moment the auction of a particular lot begins, or even during an initial portion of a particular auction event.

In some embodiments, this first bid increment is configured by an administrator of the online auction at some point prior to the start of the timed online auction event. Note that the process shown in FIG. 2 describes a single bid increment, which may be revised at one or more points during the timed event. In some embodiments, there may in fact only be a single relevant bid increment at any given time. This may be the case, for example, in an online auction process that allows bidders to submit arbitrary bid amounts or bid increases, provided only that the bid amount exceeds a previous bid amount by a certain increment. In other systems, a user is permitted to place a “maximum” bid that is higher than the current bid by at least the current bid increment, and the system automatically bids on the user's behalf up to this maximum bid, as needed to overcome other bids, in increments equal to the current bid increment. In any of these embodiments, then, the bid increment referred to in FIG. 2 represents the minimum increase, relative to the previous bid amount, that is required for a new bid.

In other embodiments, users may be limited to one of several discrete bidding options. For example, at a given stage of the auction bidders may be allowed only to select one of several increases, such as a $100, $200, $300, or $500 increase. In embodiments using this approach, the bid increment at block 210 of FIG. 2 may correspond to one of these increments; while FIG. 2 illustrates a process for revising that bid increment as the auction event progresses, it will be appreciated that one or more of the other allowed increments may be revised in a similar manner during the course of the auction. Note that still further embodiments may be based on a combination of these two approaches, e.g., providing two or more discrete increments that can be conveniently selected by the user with a single “click,” as well as providing the option for the user to enter an arbitrary bid amount or an arbitrary maximum bid amount, provided it meets a minimum increase requirement.

Referring once again to FIG. 2, block 220 shows that a current auction price and a minimum next bid value are sent to client browsers. This may be done, for example, by sending an updated version of the web page for the current lot, e.g., in response to a bidder computer's accessing the page. In some embodiments, the code for the web page includes mechanisms to force periodic refreshing of all or part of the web page at the bidder computers. Accordingly, new information can be sent to participating bidder computers by updating the web page information managed by the auction web server and sending the updated information to the bidder computers according to their periodic requests for it.

The first time the operation shown at block 220 is performed, the current auction price and the minimum next bid value are the starting auction price and the starting auction price with the first bid increment added to it, respectively. It will be appreciated, of course, that other approaches are possible. For instance, the current auction price and the first bid increment itself may be sent to the bidder computers and displayed to the users, in some embodiments. In some embodiments, the current auction price and several bid increments, including the first bid increment, are sent to the bidder computers, thus providing several options for a bidding user to select from.

As shown at block 230, one or more bids are received from client systems, i.e., bidder computers; upon each received bid, the current auction price is updated and the current auction price and the minimum next bid value (or the current auction price and the current value for the first bid increment) are again sent to client browsers.

As shown at block 240, the online auction system periodically checks to determine whether a revision event has been triggered. If not, the system checks to determine whether the auction time has expired, as shown at block 250. If the auction time expires, the online auction event is over, and the illustrated bid increment management process ends. If there is remaining time in the auction, on the other hand, the process continues with the monitoring for additional bids, as shown at block 230.

On the other hand, if a revision event occurs (see block 240), a revised bid increment is calculated, based on the remaining time in the auction and based on the current auction price for the item, as shown at block 260. The process then continues with the sending of the current auction price and minimum next bid value, which is the current auction price plus the revised bid increment, as shown at block 220. Again, of course, the current auction price and the revised bid increment may be sent, in some embodiments.

In some embodiments of the process illustrated in FIG. 2, the calculation of the revised bid increment is based on the ratio of the current auction price to a target price for the lot. In some of these embodiments, whether to revise the bid increment and/or the extent of the revision is based on comparing this ratio to a target ratio. Detailed examples of this approach are provided below. In some embodiments, for example, calculating the revised bid increment comprises detecting that the ratio of the current ratio of the current auction price to a target price for the item is within a predetermined range of ratios, and calculating the bid increment by reducing a previous bid increment, in response. The range of ratios may be associated with a particular increment time or range of increment times; thus, a different range of ratios may apply at different times as the auction provides. Again, detailed examples of this approach are provided below.

In some embodiments, the extent of the bid increment revision, or “cut,” is predetermined, e.g., by auctioneer settings, for each of one or several discrete stages. These cuts may be defined in absolute terms, or in relative terms. For example, an auction event may start with a bid increment of $100. After a first cut, the bid increment may fall to $50, and then to $25 and $10 after second and third cuts, respectively. The cuts may be defined as a ratio or ratios, e.g., each cut in the previous example represents a 50% decrease in the bid increment. More complex schemes for calculating a particular cut may also be used, including schemes that are directly based on one or more of the current bid price, the ratio of the current bid price to the target price, the time remaining in the auction event, the amount of bidding activity in an interval preceding the time at which the cut is calculated, etc.

Following are details of one example implementation of the process illustrated generally in FIG. 2. In this example, bid increments are revised in the last 65 minutes (1:05) of the auction event, and the revisions are based on the remaining time and the ratio of the current auction price to the target price (referred to hereinafter as the “target ratio”). Of course, it will be appreciated that any of the time ranges and the target ratios in this example process can be adjusted, to form a variation of this process. Similarly, more or fewer revision events may be used, in other variations.

In this particular example, there are three target ratios of interest: 70%, 80%, and 90% of the target price. These target ratios are each associated with a range of times prior to the expiration of the auction event: a 70% target ratio is associated with a time randomly selected between 1:05 and 0:45 prior to auction expiration; 80% target ratio is associated with a time randomly selected between 0:35 and 0:20; and a 90% target ratio is associated with a time randomly selected between 0:06 and 0:10. Note that while the target ratios are generally predetermined (i.e., configured before the auction event begins, either by a static program setting or via an operator-adjustable setting), the times may be randomly selected and/or adjusted during the course of the auction event, in some embodiments.

In the present example, a maximum of three revisions to the bid increment (here, called “cuts”) can be made, one at each target time/range. The amount of each cut, i.e., the extent of the bid revision, depends on the time range the revision event is in, as well as the ratio of the current auction price to the target price.

First Cut:

Whether the first cut is made is a function of the ratio of the current price for the lot item to the target price, as follows:

(a) Normal Cut—Current Bid Is Between 70%-74% of Target: A cut to the current bid increment is made between 0:45 and 1:05 left in the auction if the current bid reaches 70%-74% of the target price during this time frame. The system will randomly choose a time within this time range to see whether the cut should be made and if not, will continually check to see if 70% is reached and will make the cut if the current lot price reaches the 70%-74% of the target price for that lot. For instance, suppose that the current bid is at $10,000, which represents 70% of the target price, and the current bid increment is $500. Because the current bid is in the 70%-74% range, a cut at this stage is triggered, resulting in a revised bid increment of $250.

(b) Bid Reaches 70% With Less Than 0:45 Left in the Auction: A cut would automatically occur.

(c) Bid Is At Least 75% of Target: If the current bid is 5% or higher than the percentage for that drop stage (i.e., the time period in which a cut can occur), the cut for that level is voided and the process moves to the next stage. For example, if the 70% drop (cut) is set for 53 minutes and the current bid is at 77% of the target at 53 minutes, the drop is voided and the process moves on to the next cut stage (i.e., the 80% target ratio stage).

Note that a “catch-up” rule is employed, in some embodiments. According to this approach, if a first cut is not made because the current price is over the target percentage but the current price subsequently hits a second cut level (80%), the bid increment is revised to the pre-set level for the second stage. For example, assume that the initial bid increment is $500 and that the first cut was voided (i.e., skipped), because the current bid at that stage was higher than the target range. Further assume that the first cut would have resulted in a revised bid increment of $250. Now, if the current bid falls within the target range at the second stage, the bid increment is revise all the way down to $100, i.e., down to the same level it would have fallen to had the first cut actually taken place. Note that this rule need not be employed in every embodiment.

(d) Bid Is Between 50%-70% of Target With a Maximum Bid of At Least 80%: In some embodiments, a bidder can place a bid that is higher than the minimum next bid value. If a first bidder chooses to do so, the system will place a bid at the minimum next bid value and as other bidders place bids, the system will bid automatically on behalf of the first bidder, based on the predetermined bid increments, up to the first bidder's maximum bid. Thus, for example, if a bidder has a maximum bid at 80% of the target price but the current bid is at 60% of the target price, there hasn't been bidding activity over the 60% level to push up the bidder towards his or her maximum bid. If a bid is placed higher than 80% of the target price, the first bidder is outbid and must rebid to try to regain the high bid. If a bidder has a maximum bid in place that exceeds the 80% level, the system performs the first cut even if the actual bidding has not yet hit the lower level threshold, to stimulate bidding to reach the maximum bid. However, the system first verifies that bidding has reached at least the 50% level, in this example. The system will look for the first cut at the randomly generated first cut time and will perform the cut even if the bid hasn't yet met the target ratio of 70%. The reason this rule exists is to stimulate bidding activity, since the system already has a maximum bid placed at a ratio cut level.

(e) Bid Is Lower Than 50% of Target: No cut is made even with higher maximum bid.

Second Cut:

Whether the first cut is made is a function of the ratio of the current price for the lot item to the target price, as follows:

(a) Normal Cut—Bid Is Between 80%-84% of Target: A cut is made between 0:20 and 0:35 left in the auction if the current bid reaches 80%-84% of the target price during this time frame. The system randomly chooses a time in this time range to see whether the cut should be made and, if not, continually checks to see whether 80% is reached. The system will make the cut if the 80%-84% of the target price is met. As mentioned, the extent of the cut is according to a predetermined rule. For example, the auctioneer may have configured the system so that a 50% cut is possible at each stage. Alternatively, a particular dollar amount or percentage reduction may be associated with each stage.

(b) Bid Reaches 80% After Target Cut Time: A cut automatically occurs.

(c) Bid Is At Least 85% of Target: If the current bid is 5% or higher than the percentage for that drop stage, the cut for that level is voided and the system waits for the next stage. Again, a catch-up rule is employed. If the second cut is not made because the then-current auction price was over the target percentage, but then hit the 3rd cut level (90%), the pre-set cut for that level or the 3rd cut increment would be performed.

Third Cut:

(a) Normal Cut—Bid Is Between 90%-94% of Target: The cut is made between 0:10 and 0:06 left in the auction if the current bid reaches 90%-94% of the target price during this time frame. The system randomly chooses a time in this time range to see whether the cut should be made and, if not, continually checks to see whether 90% is reached. The cut is made if 90%-94% of the target price is met.

(b) Bid Reaches 90% After Target Cut Time: A cut automatically occurs.

(c) Bid Is At Least 95% of Target: If the current bid is 5% or higher than the percentage for that target level, a cut is performed at the random cut time even if no cut has previously occurred. Note that this behavior is different from previous stages, because this is the final stage in this example.

(d) Bid Is Between 80%-90% of Target With a Maximum Bid of At Least 95%: In this case, the cut for the third level is performed even if the bid price has not hit the lower level threshold, to stimulate bidding to reach the maximum bid. The system will look for the cut at the randomly generated cut time and will perform the cut even if the bid didn't reach 90% if (d) condition is met. Note that only one cut per time range (cut stage) is made.

(e) Bid Is Lower Than 80% of Target: No cut is made, even if there is a higher maximum bid.

If the bid reaches 80% of target and there is a maximum bid of greater than 95% after the initial target cut time, the cut would automatically occur.

Refinements and other features of this example process are possible. Other processes may use some or all of the features described above, and may use more or fewer stages than the example given above. As noted above, if the current price reaches the target ratio for a given stage after the time for that stage has expired (i.e., with less time left in the auction event than the lowest time threshold for that drop), then the system in some embodiments automatically drops the bid increment to the next drop increment level to catch up. In some cases, this rule is only applied if the current bid is less than the target price for the lot. On the other hand, if the current bid reaches a higher percentage threshold before the time range for a given target ratio even begins, no drop would occur until the time left was at that drop stage's time threshold. For instance, in the example given above, if the current bid reaches 90% of the target price with 1 hour left, the system would not apply any drop in the bid increment until the time thresholds are met in the third drop stage.

In the example detailed above, drops occur within the set three stages at a randomly computer generated time within each stage. The current bid must be at the percentage of the target price required in each stage to drop. If the current bid is 5% or higher than the percentage for that drop stage, the drop for that level is voided and the system waits for the next stage. For example, if the 70% drop is randomly set for 53 minutes and the current price at that time is at 77% of the target price, then the drop is voided and the system moves on to the 80% stage. The catch-up rule may also apply. Thus, if the first cut was skipped because the bid price at that time was over the percentage, but then the bid price during the second stage falls within the range for triggering the second cut level, then you would do the pre-set cut for that level or the second cut increment.

An automatic cut may be implemented when the current price exceeds 95% of the target, if the lot has not had a previous cut. If the system has received a maximum bid at a certain level above the current bid, the system may implement a cut even though the actual current bid has not yet reached the lower level threshold for the current stage. Both of these approaches are to stimulate bidding to reach the maximum bid value or a new level.

It will be appreciated that other features may be added to an auction system as described above. For example, any of the techniques described above can be combined with an “automatic bidding extension” feature. In a system configured according to this approach, the pre-determined length of the auction for a specific item may be extended, depending on activity that occurs during the final moments of the auction, e.g., within the last five minutes. For example, if a bid is received within the last three minutes of the auction event, the event might be automatically extended by three minutes, in some embodiments. Subsequent bids may further extend the event time, although subsequent extensions need not be the same length.

The automatic bidding extension feature may be further refined by considering the ratio of the current price to the target price when making bidding extension decisions. For instance, a system may be configured to implement an automatic bidding extension only if the ratio of the current price to the target price exceeds a particular target ratio, e.g., 70%. The length of the bidding extension may also be a function of the ratio of the current price to the target price, in some embodiments.

FIG. 3 illustrates components of an example auction server 110 according to some embodiments. Server 110 comprises a microprocessor 320 coupled to a memory circuit 330 and a network interface circuit 360. Network interface circuit 360 provides connectivity to one or more client browser systems through a data network, such as the Internet, using one or more data communication standards such as Internet Protocol (IP), Transport Control Protocol (TCP), hyper-text transmission protocol (HTTP), and the like. Circuits and protocols for communicating data through a network, including the Internet, are well known and the details of such are therefore not provided herein.

Memory circuit 330, which may include one or several types of memory such as Flash, RAM, ROM, magnetic storage devices, optical storage devices, and the like, stores program data 340, which includes computer program instructions for execution by microprocessor 320. These computer program instructions include program instructions for carrying out one or more of the techniques described above, such as the method illustrated generally in FIG. 2 or any variant of the detailed three-cut process described above. Memory circuit 330 further stores auction data 350, which comprises data elements corresponding to a target price for an auction lot, the current auction price, an initial bid increment, the current bid increment, and so on.

In view of FIG. 3, it will be appreciated that embodiments of the present invention include server apparatus for conducting timed online auctions, the server apparatus comprising a network interface circuit configured for communication with one or more network-connected user devices, and a processing circuit, where the processing circuit is configured (e.g., with appropriate program code stored in a program memory) to send to the one or more network-connected user devices, via the network interface circuit, a current auction price for an item for sale in a timed online auction event, to determine that a revision event has occurred, where said revision event is triggered by a time remaining in the timed online auction event or by a ratio of the current auction price to a target price for the item, or by a combination of both, to calculate a bid increment corresponding to said revision event, based on the time remaining in the timed online auction event and based on the current auction price for the item, and to send to the one or more network-connected user devices, via the network interface circuit, the bid increment or a minimum next bid value that is based on the current auction price and the bid increment. The variations of this process that were discussed in connection with FIG. 2 are also applicable to this server apparatus.

With these and other variations and extensions in mind, those skilled in the art will appreciate that the foregoing description and the accompanying drawings represent non-limiting examples of the systems and apparatus taught herein for facilitating load balancing in a data packet network. As such, the present invention is not limited by the foregoing description and accompanying drawings. Instead, the present invention is limited only by the following claims and their legal equivalents.

What is claimed is:

1. A method for conducting an online auction, in a server apparatus configured for communication with one or more network-connected user devices, the method comprising:
sending, to the one or more network-connected user devices, a current auction price for an item for sale in a timed online auction event;
determining that a revision event has occurred, wherein said revision event is triggered by a time remaining in the timed online auction event or by a ratio of the current auction price to a target price for the item, or by a combination of both;
calculating a bid increment corresponding to said revision event, based on the time remaining in the timed online auction event and based on the current auction price for the item; and
sending, to the one or more network-connected user devices, the bid increment or a minimum next bid value that is based on the current auction price and the bid increment.

2. The method of claim 1, wherein calculating the bid increment is based on a ratio of the current auction price to the target price for the item.

3. The method of claim 2, wherein calculating the bid increment is based on a comparison of said ratio to a target ratio.

4. The method of claim 1, further comprising randomly selecting a time for triggering the revision event from a pre-determined range of time prior to the end of the timed event, wherein determining that the revision event has occurred comprises detecting that the selected time has arrived.

5. The method of claim 1, wherein calculating the bid increment comprises:
detecting that the ratio of the current ratio of the current auction price to a target price for the item is within a predetermined range of ratios, wherein said range of ratios is associated with an increment time or range of increment times; and
calculating the bid increment by reducing a previous bid increment, in response to said detecting.

6. The method of claim 1, wherein calculating the bid increment comprises:
detecting whether the ratio of the current ratio of the current auction price to a target price for the item is within a predetermined range of ratios, wherein said range of ratios is associated with an increment time or range of increment times; and
calculating the bid increment by reducing a previous bid increment, in response to detecting that said ratio is within the predetermined range of ratios, and otherwise setting the bid increment to equal the previous bid increment.

7. The method of claim 1, wherein calculating the bid increment comprises, for each of two or more increment times or ranges of increment times:
detecting whether the ratio of the current ratio of the current auction price to a target price for the item is within a predetermined range of ratios, wherein said range of ratios is associated with the increment time or range of increment times; and
calculating the bid increment by reducing a previous bid increment, in response to detecting that said ratio is within the predetermined range of ratios, and otherwise setting the bid increment to equal the previous bid increment.

8. The method of claim 7, wherein each calculating of the bid increment corresponds to a time randomly selected from a pre-determined range of time prior to the end of the timed event.

9. The method of claim 1, the method further comprising automatically extending a duration for the timed online auction event, based on bidding activity occurring within a predetermined time before a scheduled end time for the timed online auction event.

10. The method of claim 9, wherein automatically extending the duration for the timed online auction event comprises calculating a length for the extension, based on a a ratio of the current auction price to the target price for the item.

11. A server apparatus for conducting timed online auctions, the server apparatus comprising a network interface circuit configured for communication with one or more network-connected user devices, and
a processing circuit configured to:
send to the one or more network-connected user devices, via the network interface circuit, a current auction price for an item for sale in a timed online auction event;
determine that a revision event has occurred, wherein said revision event is triggered by a time remaining in the timed online auction event or by a ratio of the current auction price to a target price for the item, or by a combination of both;
calculate a bid increment corresponding to said revision event, based on the time remaining in the timed online auction event and based on the current auction price for the item; and
send to the one or more network-connected user devices, via the network interface circuit, the bid increment or a minimum next bid value that is based on the current auction price and the bid increment.

12. The server apparatus of claim 11, wherein the processing circuit is configured to calculate the bid increment based on the ratio of the current auction price to the target price for the item.

13. The server apparatus of claim 12, wherein the processing circuit is configured to calculate the bid increment based on a comparison of said ratio to a target ratio.

14. The server apparatus of claim 11, wherein the processing circuit is further configured to randomly select a time for triggering the revision event from a pre-determined range of time prior to the end of the timed event and to determine that the revision event has occurred comprises detecting that the selected time has arrived.

15. The server apparatus of claim 11, wherein the processing circuit is configured to calculate the bid increment by:
detecting that the ratio of the current ratio of the current auction price to a target price for the item is within a predetermined range of ratios, wherein said range of ratios is associated with an increment time or range of increment times; and
calculating the bid increment by reducing a previous bid increment, in response to said detecting.

16. The server apparatus of claim 11, wherein the processing circuit is configured to calculate the bid increment by:
detecting whether the ratio of the current ratio of the current auction price to a target price for the item is within a predetermined range of ratios, wherein said range of ratios is associated with an increment time or range of increment times; and
calculating the bid increment by reducing a previous bid increment, in response to detecting that said ratio is within the predetermined range of ratios, and otherwise setting the bid increment to equal the previous bid increment.

17. The server apparatus of claim 11, wherein the processing circuit is configured to calculate the bid increment by, for each of two or more increment times or ranges of increment times:
detecting whether the ratio of the current ratio of the current auction price to a target price for the item is within a predetermined range of ratios, wherein said range of ratios is associated with the increment time or range of increment times; and
calculating the bid increment by reducing a previous bid increment, in response to detecting that said ratio is within the predetermined range of ratios, and otherwise setting the bid increment to equal the previous bid increment.

18. The server apparatus of claim 17, wherein each calculating of the bid increment corresponds to a time randomly selected from a pre-determined range of time prior to the end of the timed event.
